(19) United States
(12) Patent Application Publication
(10) Pub. No.: US 2009/0107879 A1
(43) Pub. Date: Apr. 30, 2009

(54) PACKING MEMBER FOR HONEYCOMB STRUCTURE AND METHOD FOR TRANSPORTING HONEYCOMB STRUCTURE

(75) Inventors: Mutsuo Otsuka, Dunavarsany (HU); Andras Teleki, Dunavarsany (HU)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/235,296

(22) Filed: Sep. 22, 2008

(30) Foreign Application Priority Data
Oct. 31, 2007 (JP) PCT/JP2007/071238

(51) Int. Cl. B65D 81/113; B32B 3/00; B32B 1/08; B65D 81/02; B32B 1/02

(52) U.S. Cl. 206/589; 428/172; 428/34.1; 428/35.2; 414/806; 414/808; 206/523; 220/745

(57) ABSTRACT

A packing member for a honeycomb structure includes a holding member and a covering member. The holding member includes a recessed portion having a bottom face and a side face. The holding member is configured to hold the honeycomb structure in the recessed portion. The recessed portion has a corner portion which includes a border portion between the bottom face and the side face. The covering member covers at least the recessed portion and is provided to form a gas layer between the covering member and the corner portion.

### CROSS-REFERENCE TO RELATED APPLICATIONS

The present application claims priority under 35 U.S.C. § 119 to PCT Application No. PCT/JP2007/071238, filed Oct. 31, 2007, the contents of which are incorporated herein by reference in their entirety.

### BACKGROUND OF THE INVENTION

1. Field of the Invention

The present invention relates to a packing member for a honeycomb structure and a method for transporting a honeycomb structure.

2. Discussion of the Background

In recent years, particulate matter (hereinafter, also referred to as PM) contained in exhaust gases discharged from internal combustion engines such as diesel engines have raised serious problems as contaminants harmful to the environment and the human body.

For this reason, various honeycomb structures, which are made of porous ceramics such as cordierite and silicon carbide, have been proposed as filters that capture PM in exhaust gases and purify the exhaust gases.

During processes, such as packaging and transporting of honeycomb structures and the like, however, an impact such as vibration is applied to the honeycomb structures; there exists a problem that the outer edge portion (in particular, the peripheral coat layer of the honeycomb structure) of the end face of each honeycomb structure is more susceptible to breakage such as chipping and cracking.

In order to solve this problem, a packing member for honeycomb structures that protects the honeycomb structure from an impact, such as vibration, has been proposed (see JP-A 2005-280783 and JP-A 2004-042964).

JP-A 2005-280783 discloses a packing member for honeycomb structures characterized by including a box, a holding member that is placed in the box and has a recessed portion used for holding a honeycomb structure, and a cushion member placed between the holding member and the box. This Document discloses that the honeycomb structure and the holding member can be made in close contact with each other by inserting a resin sheet or a paper cloth between the recessed portion of the holding member and the honeycomb structure.

Moreover, JP-A 2004-042964 discloses a packing member for honeycomb structures which is configured by a box and a lid member placed on the upper face side of the box, with a protective member being placed between the lid member and the honeycomb structure.

The contents of JP-A 2005-280783 and JP-A 2004-042964 are incorporated herein by reference in their entirety.

### SUMMARY OF THE INVENTION

According to one aspect of the present invention, a packing member for a honeycomb structure includes a holding member and a covering member. The holding member includes a recessed portion having a bottom face and a side face. The holding member is configured to hold the honeycomb structure in the recessed portion. The recessed portion has a corner portion which includes a border portion between the bottom face and the side face. The covering member covers at least the recessed portion and is provided to form a gas layer between the covering member and the corner portion.

According to another aspect of the present invention, a method for transporting a honeycomb structure includes providing a packing member for a honeycomb structure. The packing member includes a holding member and a covering member. The holding member includes a recessed portion having a bottom face and a side face. The holding member is configured to hold the honeycomb structure in the recessed portion. The recessed portion includes a corner portion including a border portion between the bottom face and the side face. The covering member covers at least the recessed portion and provided to form a gas layer between the covering member and the corner portion. The honeycomb structure is placed on the recessed portion of the holding member of the packing member. The honeycomb structure is packed with the packing member. The packing member is transported in which the honeycomb structure has been packed.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is an exploded perspective view that schematically shows a mode in which honeycomb structures are being packed in the conventional packing member for honeycomb structures (the packing member for honeycomb structures described in JP-A 2005-280783).

FIG. 1B is a cross-sectional view (E-E line cross-sectional view of FIG. 1A) that schematically shows a cross section obtained by cutting the packing member for honeycomb structures shown in FIG. 1A in a direction perpendicular to the bottom face of the recessed portion of the holding member.

FIG. 2 is a partially expanded cross-sectional view that schematically shows the neighborhood of the recessed portion of the holding member in the cross-sectional view shown in FIG. 1B.

FIG. 3A is a partially expanded cross-sectional view that schematically shows a cross section of the neighborhood of a recessed portion of a holding member taken in a direction perpendicular to the bottom face of the recessed portion about one example of a packing member for honeycomb structures according to one embodiment of the present invention.

FIG. 3B is a partially expanded cross-sectional view that schematically shows a mode in which a honeycomb structure is placed on the recessed portion of the holding member of the packing member for honeycomb structures shown in FIG. 3A.

FIG. 4A is a perspective view that schematically shows one example of a packing member for honeycomb structures according to one embodiment of the present invention, and FIG. 4B is a plan view of the packing member for honeycomb structures shown in FIG. 4A.

FIG. 4C is a cross-sectional view that schematically shows a cross section obtained by cutting the packing member for honeycomb structures shown in FIG. 4A in a direction perpendicular to the bottom face of a recessed portion of a holding member (A-A line cross-sectional view of FIGS. 4A and 4B).

FIG. 5A is an exploded perspective view that schematically shows a mode in which honeycomb structures are being packed in the packing member for honeycomb structures according to the embodiment of the present invention shown in FIG. 4A, and further contained in a box.

FIG. 5B is a cross-sectional view (B-B line cross-sectional view of FIG. 5A) that schematically shows a cross section obtained by cutting the box containing the packing member for honeycomb structures shown in FIG. 5A in a direction perpendicular to the bottom face of the recessed portion of the holding member.

FIG. 6 is an explanatory drawing of the vibration testing device.

FIG. 7A is a perspective view that schematically shows another example of a packing member for honeycomb structures according to one embodiment of the present invention, and FIG. 7B is a plan view of the packing member for honeycomb structures shown in FIG. 7A.

FIG. 7C is a cross-sectional view that schematically shows a cross section obtained by cutting the packing member for honeycomb structures shown in FIG. 7A in a direction perpendicular to the bottom face of a recessed portion of a holding member (C-C line cross-sectional view of FIGS. 7A and 7B).

FIG. 8A is a perspective view that schematically shows still another example of a packing member for honeycomb structures according to one embodiment of the present invention, and FIG. 8B is a plan view of the packing member for honeycomb structures shown in FIG. 8A.

FIG. 8C is a cross-sectional view that schematically shows a cross section obtained by cutting the packing member for honeycomb structures shown in FIG. 8A in a direction perpendicular to the bottom face of a recessed portion of a holding member (D-D line cross-sectional view of FIGS. 8A and 8B).

### DESCRIPTION OF THE EMBODIMENTS

The embodiments will now be described with reference to the accompanying drawings, wherein like reference numerals designate corresponding or identical elements throughout the various drawings.

Even when the packing member for honeycomb structures described in JP-A 2005-280783 and JP-A 2004-042964 is used, a phenomenon in which ceramic powder is more prone to flaking (hereinafter, referred to also as frictional damage) due to a rubbed honeycomb structure (in particular, a peripheral coat layer). Moreover, there remains a problem in which the portion having the frictional damage develops a crack, resulting in breakage, such as chipping of the honeycomb structure and flaking of the peripheral coat layer. Therefore, there have been strong demands for preventing the occurrence of this frictional damage.

A packing member for a honeycomb structure according to embodiments of the present invention tends to prevent the occurrence of deterioration, such as breakage and frictional damage, in the honeycomb structure, while conventional packing members for a honeycomb structure have the above phenomena. Further, a packing member for a honeycomb structure according to the embodiments of the present invention can provide a method for transporting a honeycomb structure by using the packing member for a honeycomb structure. The following description will discuss these.

A conventional packing member for honeycomb structures having a structure, in which honeycomb structures are packed with a resin sheet being inserted between a recessed portion of a holding member and a round pillar-shaped honeycomb structure, was studied.

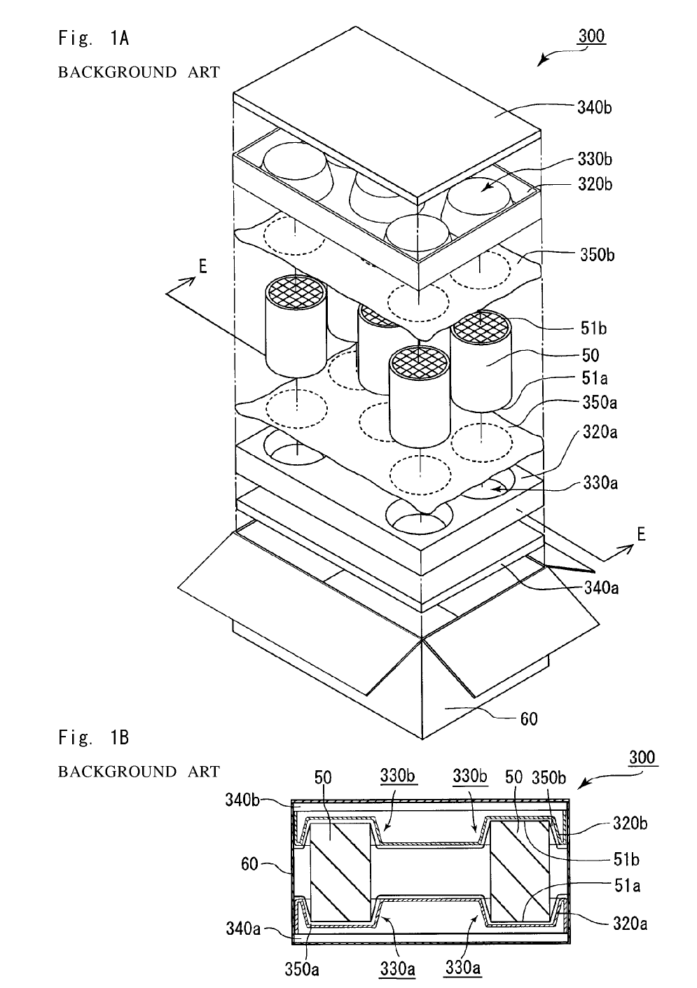

FIG. 1A is an exploded perspective view that schematically shows a mode in which honeycomb structures are being packed in the conventional packing member for honeycomb structures (the packing member for honeycomb structures described in JP-A 2005-280783). FIG. 1B is a cross-sectional view (E-E line cross-sectional view of FIG. 1A) that schematically shows a cross section obtained by cutting the packing member for honeycomb structures shown in FIG. 1A in a direction perpendicular to the bottom face of the recessed portion of the holding member.

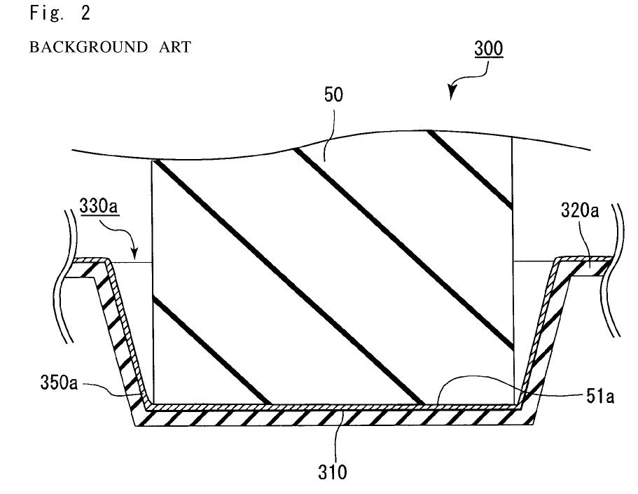

FIG. 2 is a partially expanded cross-sectional view that schematically shows the neighborhood of the recessed portion of the holding member in the cross-sectional view shown in FIG. 1B.

As shown in FIGS. 1A and 1B, the packing member for honeycomb structures described in JP-A 2005-280783 is configured by a box 60, and a holding member 320a and a holding member 320b to be placed in the box 60. Here, a cushion member 340a is placed between the box 60 and the holding member 320a. Moreover, a cushion member 340b is placed between the box 60 and the holding member 320b.

Furthermore, recessed portions 330a (330b) in each of which are placed the end portions of each honeycomb structure 50, are formed on the holding member 320a (320b). Moreover, a resin sheet 350a (350b) is affixed onto the surface of the holding member 320a (320b) on which the recessed portions 330a (330b) are formed.

Referring to FIGS. 1A and 1B, the following description will discuss processes in which honeycomb structures are packed by using a conventional packing member 300 for honeycomb structures having this structure.

In FIGS. 1A and 1B, two end portions of each honeycomb structure 50 are placed on each recessed portion 330a of the holding member 320a and each recessed portion 330b of the holding member 320b. Moreover, the resin sheet 350a is inserted between each honeycomb structure 50 and each recessed portion 330a of the holding member 320a, while being in contact with each end face 51a of the honeycomb structures 50 and each recessed portion 330a of the holding member 320a. In the same manner, a resin sheet 350b is inserted between each honeycomb structure 50 and each recessed portion 330b of the holding member 320b, while being in contact with each end face 51b of the honeycomb structures 50 and each recessed portion 330b of the holding member 320b.

Moreover, contained in the box 60 are the holding member 320a and the holding member 320b, in which the honeycomb structure 50 has been placed, together with the cushion member 340a and the cushion member 340b.

It is presumed that, in this packing member 300 for honeycomb structures shown in FIG. 2, the surface 310 of the recessed portion 330a of the holding member 320a and the lower face of the resin sheet 350a are brought in close contact with each other without any gap. Moreover, it is presumed that the upper face of the resin sheet 350a and the end face 51a of the honeycomb structure 50 are brought in close contact with each other without any gap. That is, it is considered that the packing member 300 for honeycomb structures disclosed in JP-A 2005-280783 has a structure in which the recessed portion 330a of the holding member 320a and the honeycomb structure 50 are brought in close contact with each other without any gap, with the resin sheet 350a interposed therebetween, and formed into a secured state.

Similarly, in the holding member 320b also, the recessed portion 330b of the holding member 320b and the honeycomb structure 50 are brought in close contact with each other, with the resin sheet 350b interposed therebetween without any gap, and formed into a secured state.

In such a conventional packing member for honeycomb structures, the reason for the occurrence of ceramic powder presumably due to frictional damage is described as follows.

As described above, at the time of packing honeycomb structures in the packing member for honeycomb structures, each recessed portion of the holding member and each honeycomb structure are secured to each other with the resin sheet interposed therebetween. Therefore, it is considered that, even upon application of an impact such as vibration to the packing member for honeycomb structures, deterioration, such as breakage and frictional damage, hardly occur in the initial state.

However, in the case when an impact such as vibration is continuously applied to the packing member for honeycomb structures, small stress is continuously applied to the recessed portion of the holding member, the resin sheet and the honeycomb structures.

The holding member and the resin sheet, made of materials such as cardboard and a resin, are softer than the honeycomb structure and the peripheral coat layer of the honeycomb structure that are made of ceramic materials and the like, and have lower strength. Consequently, when such a small stress is continuously applied to the recessed portion of the holding member and the resin sheet, the shape of the recessed portion of the holding member or the resin sheet tends to be gradually changed. It is considered that, as a result, gaps are generated among the recessed portion of the holding member, the resin sheet and the honeycomb structures.

The recessed portion of the holding member, the resin sheet and the honeycomb structures are brought into an unsecured state when such gaps are generated among the recessed portion of the holding member, the resin sheet and the honeycomb structures. Moreover, upon application of vibration to the packing member for honeycomb structures in this unsecured state of the recessed portion of the holding member, the resin sheet and the honeycomb structures, the stress to be generated in the honeycomb structures increases due to a force transmitted thereto through the resin sheet. It is considered that this increased stress causes frictional damage in the honeycomb structures.

That is, in the case when an impact such as vibration is applied to this conventional packing member for honeycomb structures, it is presumed that a stress that causes what is called fretting fatigue and fretting wear (hereinafter, referred to also simply as fretting stress), such as a repeated stress and a variable stress is generated due to interaction between the resin sheet and the honeycomb structure. It is considered that, when such a fretting stress is repeatedly applied to the honeycomb structures, the honeycomb structures are rubbed by the resin sheet and then flaking of ceramic powder (frictional damage) is generated. Subsequently, depending on circumstances, the portion having the frictional damage develops a crack, resulting in breakage, such as chipping of the honeycomb structure and flaking of the peripheral coat layer.

A packing member for a honeycomb structure according to one embodiment of the present invention includes: a holding member provided with a recessed portion having a bottom face and a side face and configured to place a honeycomb structure on the recessed portion to hold the honeycomb structure; and a covering member covering at least one portion of the holding member including the recessed portion, wherein the recessed portion of the holding member is provided with a corner portion including: a border portion between the bottom face and the side face; and the neighborhood of the border portion, and the covering member is disposed so as to form a gas layer between the covering member and the corner portion.

With this structure, the packing member for honeycomb structures according to the embodiment of the invention tends to prevent the occurrence of deterioration such as breakage and frictional damage of the honeycomb structures.

Referring to Figures, the following description will discuss the packing member for honeycomb structures according to the embodiment of the present invention in detail.

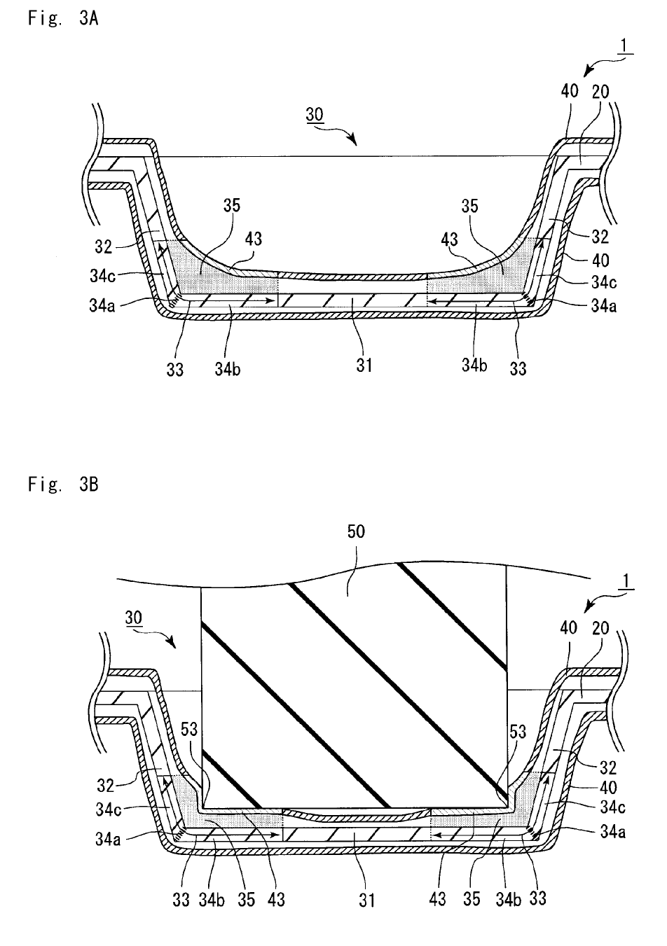

FIG. 3A is a partially expanded cross-sectional view that schematically shows a cross section of the neighborhood of a recessed portion of a holding member taken in a direction perpendicular to the bottom face of the recessed portion about one example of a packing member for honeycomb structures according to the embodiment of the present invention.

Moreover, FIG. 3B is a partially expanded cross-sectional view that schematically shows a mode in which a honeycomb structure is placed on the recessed portion of the holding member of the packing member for honeycomb structures according to the embodiment of the present invention shown in FIG. 3A.

A packing member 1 for honeycomb structures according to the embodiment of the present invention is configured by a holding member 20 having recessed portions 30, each configured by a bottom face 31 and a side face 32, and a covering member 40 that covers the entire holding member 20.

Here, each recessed portion 30 has a corner portion 33 (portion indicated by an arrow with two heads in FIG. 3A) including the border portion between the bottom face 31 and the side face 32 and the neighborhood of the border portion.

In the present specification, it is supposed that the corner portion 33 of the recessed portion 30 (hereinafter, referred to also simply as a “corner portion”) refers to a portion including a border 34a between the bottom face 31 and the side face 32, a neighborhood 34b of the border 34a in the bottom face 31 and a neighborhood 34c of the border 34a in the side face 32.

Moreover, for example, the holding member 20 is sealed inside the covering member 40, with a gas being contained between the holding member 20 and the covering member 40, so that a gas layer 35 is formed between the corner portion 33 and the covering member 40.

Here, the gas layer 35 is allowed to have such elasticity that it is deformed upon application of a load thereto, but returns to its original shape when the load has been removed. For this reason, when a load is applied to a gas layer forming portion 43 that is one portion of the covering member 40 and forms the gas layer 35, the shape of the gas layer 35 changes with the change in the shape of the gas layer forming portion 43. However, upon removal of the load, the shape of the gas layer 35 returns to its original shape by the elasticity possessed by the gas layer 35 so that the shape of the gas layer forming portion 43 is returned to its original shape in accordance with the change in the shape of the gas layer 35.

That is, the gas layer 35 serves as a cushion to absorb the impact (load) such as vibration.

Referring to FIG. 3B, the following description will discuss a structure in which honeycomb structures are packed in such a packing member for honeycomb structures according to the embodiment of the present invention.

As shown in FIG. 3B, in a state where the end portion of each honeycomb structure 50 is placed on the recessed portion 30 of the holding member 20 with the covering member 40 interposed therebetween, the gas layer 35 is formed between the covering member 40 and the corner portion 33. With the gas layer 35 located between the covering member 40 and the corner portion 33, an outer edge 53 of the end face of the honeycomb structure 50 and the neighborhood of the outer edge 53 are in contact with the gas layer forming portion 43. That is, the honeycomb structure 50 is held by the holding member 20 with the gas layer 35 interposed therebetween.

In the case when honeycomb structures 50 are packed in the packing member 1 for honeycomb structures, with each honeycomb structure 50 being held by the holding member 20 in this manner, even upon application of an impact onto the packing member 1 for honeycomb structures, the impact applied to the packing member 1 for honeycomb fired bodies tends to be absorbed by the gas layer 35. Therefore, the honeycomb structures 50 tend to be free from the application of a strong impact.

For this reason, the packing member for honeycomb structures according to the embodiment of the present invention makes it easier to prevent the occurrence of breakage in the honeycomb structures.

Next, referring to FIG. 3B, the following description will discuss a state in which an impact such as vibration is continuously applied to the packing member for honeycomb structures according to the embodiment of the present invention in which honeycomb structures have been packed.

In the case when an impact such as vibration is continuously applied to the packing member 1 for honeycomb structures in which the honeycomb structures 50 have been packed, a small stress is continuously applied to: the outer edge 53 of the end face of each honeycomb structure 50 and the neighborhood of the outer edge 53; and the gas layer forming portion 43 that is in contact with the outer edge 53 and the neighborhood of the outer edge 53. For this reason, it is presumed that the shape of the gas layer forming portion 43 is deformed to cause a gap between: the gas layer forming portion 43; and the outer edge 53 of the end face of each honeycomb structure 50 and the neighborhood of the outer edge 53. However, since the gas layer 35 located between the covering member 40 (gas layer forming portion 43) and the corner portion 33 has an elasticity, the gas layer forming portion 43 is allowed to receive a pressing force in a direction toward the outer edge 53 of the end face of each honeycomb structure 50 and the neighborhood of the outer edge 53 by the gas layer 35 so that presumably, the shape is returned to its original shape. For this reason, it is considered that, even upon continuous application of an impact such as vibration to the packing member 1 for honeycomb structures, a gap is hardly generated between: the outer edge 53 of the end face of each honeycomb structure 50 and the neighborhood of the outer edge 53; and the gas layer forming portion 43.

Therefore, in the packing member for honeycomb structures according to the embodiment of the present invention, even upon continuous application of an impact such as vibration to the packing member for honeycomb structures, the secured state of the recessed portions of the holding member, the covering member and the honeycomb structures can be maintained. Moreover, even in the case when vibration is continuously applied to the packing member for honeycomb structures with these members being secured, it is presumed that the stress to be generated in the honeycomb structures due to a stress transmitted thereto through the covering member is hardly increased.

For this reason, the packing member for honeycomb structures according to the embodiment of the present invention tends to prevent the occurrence of frictional damage in the honeycomb structures.

The packing member for honeycomb structures according to the embodiment of the present invention therefore tends to prevent the occurrence of deterioration, such as breakage and frictional damage of the honeycomb structures.

In a packing member for honeycomb structures according to one embodiment of the present invention, the covering member is made of a resin.

In accordance with the packing member for honeycomb structures according to the embodiment of the present invention, even in the case when an impact such as vibration is continuously applied to the packing member for honeycomb structures, the covering member is less susceptible to rupture or the like. For this reason, the packing member for honeycomb structures according to the embodiment of the present invention is less prone to leakage of the gas from the gas layer, thereby making it easier to maintain the gas layer with elasticity.

In the packing member for honeycomb structures according to one embodiment of the present invention, the covering member covers the entire portion of the holding member.

In the packing member for honeycomb structures according to one embodiment of the present invention, the holding member is sealed by the covering member.

In accordance with the packing member for honeycomb structures according to the embodiment of the present invention, ceramic powder adhering onto the surface of the covering member tends not to be allowed to adhere to the holding member, which tends not to cause fouling in the holding member due to ceramic powder.

Moreover, even in the case when ceramic power has adhered to the covering member, only the covering member may be replaced without the necessity of washing or the like of the holding member, so that the holding member tends to be reused.

Therefore, since the packing member for honeycomb structures according to the embodiment of the present invention is capable of recycling the holding member, it is possible to provide a packing member for honeycomb structures that tends to reduce the environmental load and also to cut transportation costs and the like.

In the packing member for honeycomb structures according to one embodiment of the present invention, the covering member has a bag shape with one opening portion or a tube shape with two opening portions before the holding member is sealed by the covering member, and by sealing the opening portion, the holding member is sealed by the covering member.

In the packing member for honeycomb structures according to one embodiment of the present invention, the opening portion is sealed by thermal compression bonding.

In accordance with the packing member for honeycomb structures according to the embodiment of the present invention, a gas layer is formed between the covering member and the corner portion, that is, between the covering member and the holding member. Moreover, the holding member and the covering member are sealed with each other through thermal compression bonding. For this reason, the packing member for honeycomb structures is less susceptible to leakage of the gas from the gas layer, thereby making it easier to surely maintain the gas layer with elasticity.

Therefore, the resulting packing member for honeycomb structures according to the embodiment of the present invention becomes highly effective to prevent the occurrence of deterioration in the honeycomb structures.

In the packing member for honeycomb structures according to one embodiment of the present invention, the holding member and the covering member are secured to each other.

In accordance with the packing member for honeycomb structures according to the embodiment of the present invention, for example, by securing the holding member and the covering member to each other after the recessed portions of the holding member have been covered with the covering member, a gas layer is formed between the corner portion and the covering member.

Therefore, in the packing member for honeycomb structures according to the embodiment of the present invention, it is possible to provide a packing member for honeycomb structures that is highly effective to prevent the occurrence of deterioration in the honeycomb structures.

In the packing member for honeycomb structures according to one embodiment of the present invention, the holding member and the covering member are secured to each other by a securing member.

In the packing member for honeycomb structures according to one embodiment of the present invention, the holding member and the covering member are secured to each other by thermal compression bonding.

In accordance with the packing member for honeycomb structures according to the embodiment of the present invention, a gas layer is formed between the covering member and the corner portion, that is, between the covering member and the holding member. Moreover, the holding member and the covering member are firmly sealed with each other through thermal compression bonding. For this reason, the packing member for honeycomb structures is less susceptible to leakage of the gas from the gas layer formed between the holding member and the covering member, through a gap between the holding member and the covering member. Therefore, it may become easier to maintain the gas layer with elasticity.

Therefore, the resulting packing member for honeycomb structures according to the embodiment of the present invention becomes highly effective to prevent the occurrence of deterioration in the honeycomb structures.

In the packing member for honeycomb structures according to one embodiment of the present invention, the holding member is provided with a vent that allows a gas to come in and go out of the gas layer, and the vent is capable of being opened and closed.

In accordance with the packing member for honeycomb structures according to the embodiment of the present invention, after honeycomb structures have been held on the holding member with the gas layer interposed therebetween by using a packing member for honeycomb structures according to the embodiment of the present invention, for example, through a process in which, after the gas layer has been further filled with a gas through the vent, the vent is closed by a plugging member, or a process in which, after the gas has been sucked from the gas layer through the vent, the vent is closed by a plugging member, the elasticity of the gas layer tends to be adjusted on demand.

Therefore, by taking into account the number, the outer shape and the like of honeycomb structures to be packed, the elasticity of the gas layer formed between the covering member and the corner portion tends to be adjusted so as to allow the gas layer to effectively absorb the impact. For this reason, even in the case when honeycomb structures are packed in the packing member for honeycomb structures and when an impact is applied to the packing member for honeycomb structures, the impact to be applied to the honeycomb structures tends to be effectively absorbed by the gas layer so that the occurrence of breakage in the honeycomb structures tends to be prevented more effectively.

Moreover, by taking into account the number, the outer shape and the like of honeycomb structures to be packed, the elasticity of the gas layer formed between the covering member and the corner portion tends to be adjusted so as to effectively prevent the occurrence of a gap between the gas layer forming portion and the honeycomb structure. For this reason, even in the case when honeycomb structures are packed in the packing member for honeycomb structures and when an impact such as vibration is continuously applied thereto, the shape of the gas layer forming portion tends to be readily returned to its original shape by the elasticity of the gas layer. Therefore, it may become easier to more effectively prevent the occurrence of a gap between: the gas layer forming portion; and the outer edge portion of the end face of the honeycomb structure and the neighborhood of the outer edge portion. Since it may become easier to prevent a stress generated in the honeycomb structures by the stress transmitted thereto through the covering member from increasing, it may consequently become easier to more efficiently prevent the occurrence of frictional damage in the honeycomb structures.

For these reasons, the packing member for honeycomb structures according to the embodiment of the present invention makes it possible to provide a packing member for honeycomb structures that is highly effective to prevent the occurrence of deterioration, such as breakage and frictional damage, in the honeycomb structures.

In the packing member for honeycomb structures according to one embodiment of the present invention, the vent is disposed on the side face or the bottom face of the recessed portion.

The method for transporting a honeycomb structure according to one embodiment of the present invention is a method for transporting a honeycomb structure, by using a packing member for a honeycomb structure according to the embodiments of the present invention, the method including: placing a honeycomb structure on the recessed portion of the holding member of the packing member for a honeycomb structure according to any of the embodiments of the present invention; packing the honeycomb structure with the packing member for a honeycomb structure; and transporting the packing member for a honeycomb structure in which the honeycomb structure has been packed.

That is, in the method for transporting honeycomb structures according to the embodiment of the present invention, honeycomb structures are packed by using a packing member for honeycomb structures according to the embodiments of the present invention that is highly effective to prevent the occurrence of deterioration, such as breakage and frictional damage, in the honeycomb structures and then transported. Therefore, even upon application of an impact such as vibration to the honeycomb structures, it may become easier to transport the honeycomb structures without any occurrence of deterioration in the honeycomb structures.

In the method for transporting honeycomb structures according to one embodiment of the present invention, by placing an upper end portion and a lower end portion of the honeycomb structure on the recessed portions of the holding member, the honeycomb structure is packed by the packing member for a honeycomb structure.

In accordance with the method for transporting honeycomb structures according to the embodiment of the present invention, a packing member for honeycomb structures according to the embodiments of the present invention, which is highly effective to prevent the occurrence of deterioration, such as breakage and frictional damage, in the honeycomb structures, is used, and the upper end portion and lower end portion of each of the honeycomb structures are placed on the recessed portions of the holding member, so that the honeycomb structures are packed by the packing member for honeycomb structures and then transported. Therefore, even upon application of an impact such as vibration to the honeycomb structures, it may become easier to transport the honeycomb structures without any occurrence of deterioration in the honeycomb structures.

### First Embodiment

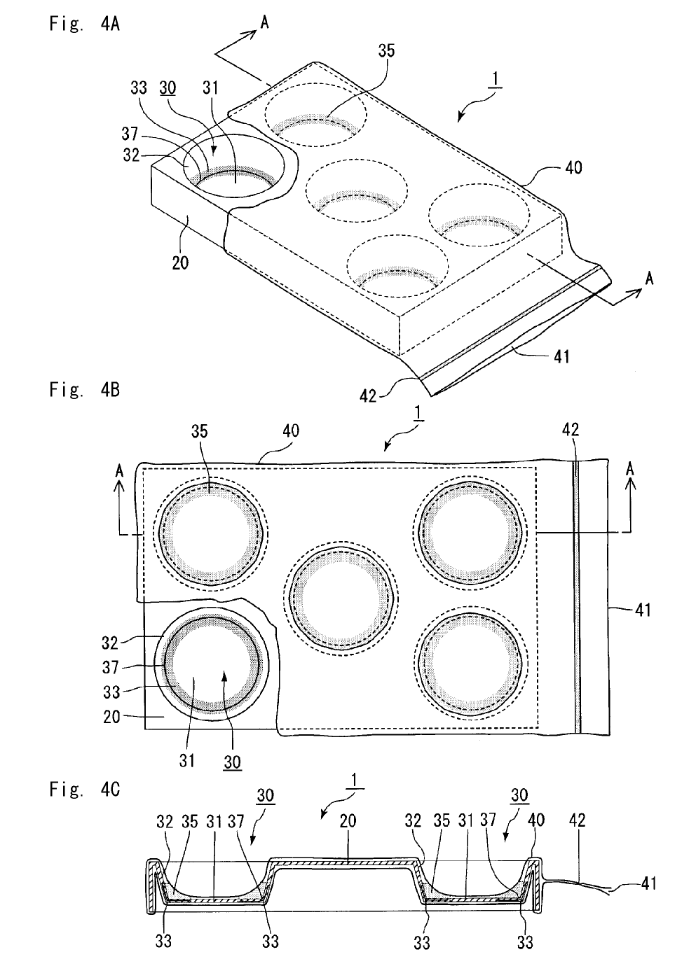

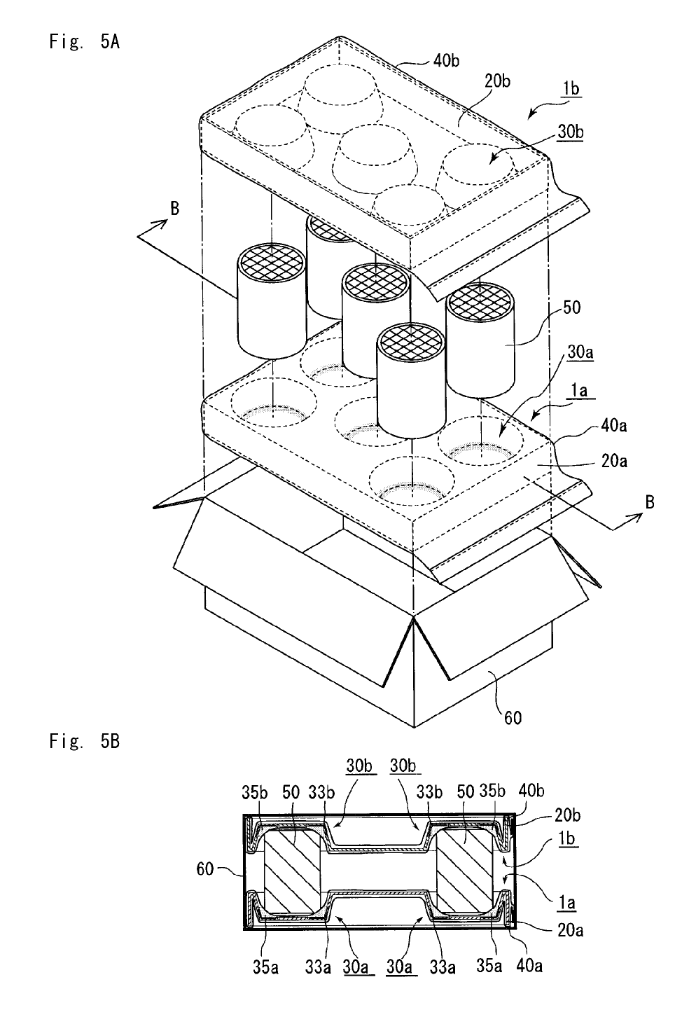

Referring to FIGS. 4A, 4B, 4C, 5A and 5B, the following description will discuss a first embodiment that is one embodiment of the present invention.

FIG. 4A is a perspective view that schematically shows one example of a packing member for honeycomb structures according to one embodiment of the present invention, and FIG. 4B is a plan view of the packing member for honeycomb structures shown in FIG. 4A. FIG. 4C is a cross-sectional view that schematically shows a cross section obtained by cutting the packing member for honeycomb structures shown in FIG. 4A in a direction perpendicular to the bottom face of a recessed portion of a holding member (A-A line cross-sectional view of FIGS. 4A and 4B).

Here, FIGS. 4A and 4B show a state in which one portion of a covering member is cut out so as to show the recessed portion of the holding member.

FIG. 5A is an exploded perspective view that schematically shows a mode in which honeycomb structures are being packed in the packing member for honeycomb structures according to the embodiment of the present invention shown in FIG. 4A, and further contained in a box. Moreover, FIG. 5B is a cross-sectional view (B-B line cross-sectional view of FIG. 5A) that schematically shows a cross section obtained by cutting the box containing the packing member for honeycomb structures shown in FIG. 5A in a direction perpendicular to the bottom face of the recessed portion of the holding member.

As shown in FIGS. 4A, 4B and 4C, the packing member 1 for honeycomb structures has a structure in which the entire holding member 20 is covered with a covering member 40 having a bag shape. Moreover, a sealing portion 42 is formed near an opening portion 41 of the covering member 40 that entirely covers the holding member 20, so that the opening portion 41 of the covering member 40 is sealed. That is, in the packing member 1 for honeycomb structures, the holding member 20 is sealed inside the covering member 40.

The following description will discuss the respective members that form the packing member 1 for honeycomb structures in detail.

The holding member 20 is a plate-shaped member made of a resin, cardboard or the like. As shown in FIGS. 4A, 4B and 4C, recessed portions 30 are formed on one face of the holding member 20. Each recessed portion 30 of the holding member 20 includes a bottom face 31 and a side face 32 that is disposed perpendicularly to the periphery 37 of the bottom face 31. Here, the recessed portion 30 has a corner portion 33 (portion indicated by a two-directional arrow in FIG. 4C) including: the border portion between the bottom face 31 and the side face 32; and the neighborhood of the border portion. Moreover, the shape of the recessed portion 30 is virtually the same as one portion of the outer shape of a honeycomb structure to be placed on the recessed portion 30.

Next, the following description will discuss the covering member 40.

The covering member 40, which is made of a resin, has an opening portion 41, and is formed into a bag shape that can cover the entire holding member 20. Moreover, the opening portion 41 is sealed by thermal compression bonding so that the sealing portion 42 as shown in FIGS. 4A, 4B and 4C can be formed.

The detailed structure of the packing member for honeycomb structures, made of the respective members described above, is the same as the structure described by reference to FIG. 3A.

That is, in the packing member for honeycomb structures of the present embodiment, the covering member 40 is placed in such a manner that a gas layer 35 is formed between the covering member 40 and each corner portion 33.

Referring to FIGS. 5A and 5B, the following description will discuss a state in which honeycomb structures are packed by using the packing member for honeycomb structures according to the embodiment of the present invention having this structure.

In FIG. 5A, the lower end portion of each honeycomb structure 50 is placed on a recessed portion 30a of a holding member 20a of a packing member 1a for honeycomb structures with a covering member 40a interposed therebetween. Moreover, the upper end portion of the honeycomb structure 50 is placed on a recessed portion 30b of a holding member 20b of a packing member 1b for honeycomb structures with a covering member 40b interposed therebetween. That is, each honeycomb structure 50 is packed in a manner so as to be sandwiched from both upward and downward directions between the packing members 1a and 1b for honeycomb structures, and the packing members 1a and 1b for honeycomb structures are contained in a box 60 with the honeycomb structures 50 sandwiched therebetween.

In this manner, the detailed structure of the packing member for honeycomb structures in which honeycomb structures are packed is the same as the structure described by reference to FIG. 3B.

That is, in the case when honeycomb structures are packed in the packing member for honeycomb structures of the present embodiment, as shown in FIG. 3(b), gas layers 35 (35a, 35b) are formed between covering members 40 (40a, 40b) and corner portions 33 (33a, 33b). Moreover, honeycomb structures 50 are held on the holding members 20 (20a, 20b) with the gas layers 35 (35a, 35b) interposed therebetween, in a state where the honeycomb structures 50 are brought in contact with gas layer forming portions 43 (see FIG. 3B).

The following description will discuss a method for manufacturing a packing member for honeycomb structures in accordance with the present embodiment.

First, a plate-shaped member made of a resin, cardboard or the like is processed so that recessed portions, each having virtually the same shape of the end portion of each honeycomb structure, are formed on one face of the plate-shaped member; thus, a holding member is manufactured.

Next, a covering member, which is larger than the outer shape of the holding member and has a bag shape with one opening portion, is prepared. And then, the entire holding member is covered with the covering member.

Moreover, the elasticity of the gas layer is adjusted by filling the inside of the covering member with a gas so as to form a gas layer between the covering member and the corner portion of the holding member, or by sucking a gas from the inside of the covering member.

Lastly, the opening portion of the covering member is sealed by thermal compression bonding so that the holding member is sealed by the covering member.

The packing member for honeycomb structures of the present embodiment is manufactured by the above-mentioned processes.

The following description will discuss a method for transporting honeycomb structures by using the packing member for honeycomb structures of the present embodiment.

First, two of the packing members for honeycomb structures of the present embodiment are prepared. Then, each of lower end portions of honeycomb structures is placed on each of the recessed portions of the holding member of the packing member for honeycomb structures on the lower side with the covering member interposed therebetween. Moreover, each of upper end portions of the honeycomb structures is placed on each of the recessed portions of the holding member of the packing member for honeycomb structures on the upper side, with the covering member interposed therebetween, so that the upper packing member for honeycomb structures is mounted on the honeycomb structures. In this state, the honeycomb structures are packed in a manner so as to be sandwiched between two packing members for honeycomb structures from both upward and downward directions.

The embodiment in which honeycomb structures are packed in the packing member for honeycomb structures of the present embodiment is the same as the embodiment described by reference to FIGS. 5A and 5B.

Next, a box having virtually the same inside dimension as that of the outer shape of the packing member for honeycomb structures in which honeycomb structures are packed, is prepared. Then, the packing member for honeycomb structures in which the honeycomb structures have been packed is contained in the box, with the upper end portions of the honeycomb structures facing up and the lower end portions of the honeycomb structures facing down in the box, and the lid of the box is closed.

Next, the box that contained the packing members for honeycomb structures are placed on a loading space of a truck or the like, and transported.

Through the above-mentioned method, honeycomb structures are transported by using the packing member for honeycomb structures of the present embodiment.

The following description will summarize functions and effects of the packing member for honeycomb structures and the method for transporting honeycomb structures of the first embodiment.

(1) A corner portion is present on each recessed portion of a holding member, and a covering member is placed so as to provide a gas layer between the covering member and the corner portion. Since the gas layer, formed between the covering member and the corner portion, has elasticity, the gas layer tends to serve as a cushion to absorb an impact such as vibration.

In the case when honeycomb structures are packed in the packing member for honeycomb structures of the present embodiment and an impact is applied to the packing member for honeycomb structures, the impact tends to be absorbed by the gas layer. Therefore, a strong impact tends not to be applied to the honeycomb structures. For this reason, by using the packing member for honeycomb structures of the present embodiment, it may become easier to prevent the occurrence of breakage in the honeycomb structures.

(2) Moreover, the gas layer formed between the covering member and the corner portion has an elasticity to return to its original shape; therefore, even when the shape of the gas layer forming portion is changed, it tends to be returned to its original shape.

In the case when honeycomb structures are packed in the packing member for honeycomb structures of the present embodiment and an impact such as vibration is continuously applied to the packing member for honeycomb structures, the shape of a gas layer forming portion is changed. However, since the gas layer, formed between the covering member and the corner portion, has elasticity, a gap hardly appears between the gas layer forming portion and each honeycomb structure. For this reason, since the recessed portion of the holding member, the covering member and each honeycomb structure are kept in a secured state. Therefore, a stress generated in the honeycomb structure tends not to be increased due to the stress transmitted thereto through the covering member. Therefore, by using the packing member for honeycomb structures of the present embodiment, it may become easier to prevent frictional damage from occurring in the honeycomb structures.

(3) In the packing member for honeycomb structures, the covering member is made of a resin. Therefore, even when an impact such as vibration is continuously applied to the packing member for honeycomb structures, the covering member is less susceptible to a rupture or the like. For this reason, the packing member for honeycomb structures of the present embodiment is less prone to leakage of the gas from the gas layer, thereby making it easier to maintain the gas layer with elasticity.

(4) A gas layer is formed between the covering member and the corner portion, that is, between the covering member and the holding member. Moreover, the holding member and the covering member are firmly sealed by thermal compression bonding. For this reason, the packing member for honeycomb structures of the present embodiment is less susceptible to leakage of the gas in the gas layer from the opening portion, thereby making it easier to maintain the gas layer with elasticity.

(5) The covering member covers the entire holding member so that the holding member is sealed by the covering member; therefore, ceramic powder adhering onto the surface of the covering member tends not to be allowed to adhere to the holding member, which tends not to cause fouling in the holding member due to ceramic powder.

Moreover, even in the case when ceramic power has adhered to the covering member, only the covering member may be replaced so that the holding member tends to be re-used.

Therefore, since the packing member for honeycomb structures of the present embodiment is capable of recycling the holding member, it is possible to provide a packing member for honeycomb structures that tends to reduce the environmental load and also to cut transportation costs and the like.

(6) In the method for transporting honeycomb structures of the present embodiment, the honeycomb structures are packed by the packing member for honeycomb structures of the present embodiment that is highly effective to prevent the occurrence of deterioration, such as breakage and frictional damage of the honeycomb structures, and then transported.

Therefore, even when an impact such as vibration is applied to the honeycomb structures, it may become easier to transport the honeycomb structures without any occurrence of deterioration in the honeycomb structures.

The following description will discuss Examples that specifically disclose the first embodiment of the present invention; however, the present embodiment is not intended to be limited only by these Examples.

### Example 1

### (1) Manufacturing of Holding Member

A plate member made of a polypropylene resin having a thickness of 1 mm was processed into a thickness of 0.2 mm, and a holding member having an outer shape of 580 mm in width×380 mm in length×40 mm in height, with five recessed portions, each having a size of 150 mm in diameter of the bottom face×155 mm in aperture diameter was formed on one face thereof.

### (2) Covering

A covering member having a bag shape with one opening portion, which was made of a resin bag composed of polyethylene and had a size of 800 mm in length (depth)×382 mm in aperture diameter×0.04 mm in thickness, was prepared. Moreover, the holding member, manufactured in the process (1), was put into the resin bag from the opening portion. Then, the entire holding member was covered with the resin bag so that the holding member covered with the covering member was manufactured.

### (3) Gas Filling

The resin bag was filled with air through the opening portion of the covering member by using an air pump.

### (4) Sealing

The neighborhood of the opening portion of the covering member was sealed by thermal compression bonding so that a sealed portion was formed; thus, the holding member was sealed by the covering member.

Manufactured through the above-mentioned processes was a packing member for honeycomb structures in which the covering member was placed so as to form a gas layer between the covering member and each of the corner portions.

### (Vibration Test)

Honeycomb structures were packed by the packing member for honeycomb structures manufactured by the aforementioned processes, and vibration tests was carried out so that evaluation was made as to whether or not any deterioration occurred in the honeycomb structures.

Here, in the respective Examples and Comparative Examples in the present specification, a round pillar-shaped honeycomb structure having a size of 143.8 mm in diameter×150 mm in length manufactured by a conventionally known method was used as the honeycomb structure to be packed.

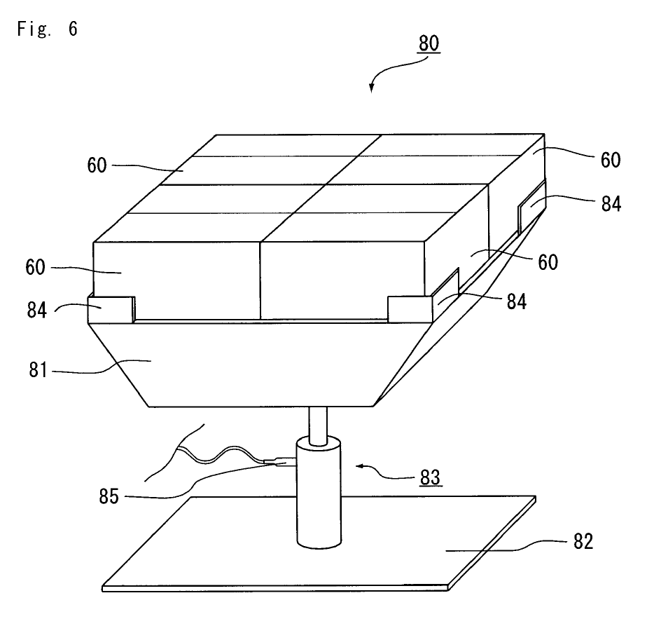

The vibration tests were carried out by using a vibration testing device as shown in FIG. 6.

FIG. 6 is an explanatory drawing of the vibration testing device.

A vibration testing device 80 is configured by a mounting base 81 on which a box 60 containing a packing member for honeycomb structures that has packed honeycomb structures is placed, and a vibration unit 83 that functions so as to connect the mounting base 81 to a base plate 82, and also generates vibrations and applies the vibrations to the mounting base 81. Moreover, a mounting member 84 used for placing the box 60 on the mounting base 81 in a stable state is attached to the mounting base 81. Furthermore, a vibration meter 85 (Digivibro Model-1332A, made by Showa Sokki Corporation), used for recording vibrations in horizontal and vertical directions generated by the vibration unit 83 as the acceleration, is attached to the vibration unit 83.

The testing method using this vibration testing device is described below.

First, 5 pieces of honeycomb structures were prepared, and the two end portions of each honeycomb structure were placed on the recessed portions of the holding members of two packing members for honeycomb structures manufactured in Example 1; thus, the honeycomb structures were packed. Next, the packing members for honeycomb structures which had packed the honeycomb structures were contained in a box having outer dimensions of 600 mm in width×400 mm in length×180 mm in height, with the upper end portion of each honeycomb structure facing up and the lower end portion of each honeycomb structure facing down in the box. Moreover, the box 60 containing the packing members for honeycomb structures was placed on the mounting base 81, and by vibrating the vibration unit 83 under conditions of an acceleration of 4.9 m/s² for 24 hours so that vibrations were applied to the box 60.

After the vibrations had been applied to the box 60, the packing members for honeycomb structures were taken out of the box 60, and each of the honeycomb structures packed in the packing members for honeycomb structures was visually examined as to whether or not any deterioration such as breakage (chipping, cracking, and the like) and frictional damage (flaking of ceramic powder and the like) occurred therein.

As a result, it was confirmed that neither breakage nor frictional damage occurred in any of the honeycomb structures. Moreover, when the surface of the holding member was observed with the covering member removed therefrom, no fouling occurred therein due to ceramic powder.

### Examples 2 to 3

The same processes as those of Example 1 were carried out to manufacture a packing member for honeycomb structures, except that the material for the covering member was changed as shown in Table 1.

### Example 4

The same processes as those of Example 1 were carried out to manufacture a packing member for honeycomb structures, except that a plate member made of cardboard having a thickness of 7 mm was processed to form the holding member in the process (1) in Example 1.

### Comparative Example 1

A packing member for honeycomb structures was manufactures by affixing a resin sheet made of polyethylene having 600 mm in width×400 mm in length×0.04 mm in thickness onto a face with recessed portions formed thereon of the holding member manufactured in the process (1) in Example 1.

### Comparative Example 2

A packing member for honeycomb structures was manufactured in the same manner as in Comparative Example 1, except that the material for the holding member was changed to the same material, cardboard, used in Example 4.

In the packing members for honeycomb structures manufactured in Comparative Examples 1 and 2, no gas layer was formed between the covering member and the corner portion.

Vibration tests were carried out in the same manner as in Example 1 on each of the packing members for honeycomb structures manufactured in Examples 2 to 4 and Comparative Examples 1 and 2, and evaluation was made as to whether or not any deterioration occurred in the honeycomb structures.

### Comparative Example 3

Honeycomb structures were directly placed on the holding member manufactured in the process (1) in Example 1 without using the covering member, and the vibration tests were carried out in the same manner as in Example 1 so that evaluation was made as to whether or not any deterioration occurred in the honeycomb structures.

Table 1 shows the materials and the like for the holding members and the covering members in the Examples and Comparative Examples, as well as the presence of a gas layer and the presence of deterioration in the honeycomb structures, together with the results of Example 1.

Here, in the case when any frictional damage occurred in the honeycomb structures, the weight of generated ceramic powder was measured. The results of the measurements are also shown in Table 1.

TABLE 1

| | | | | | | Presence of deterioration | |
|---|---|---|---|---|---|---|---|
| | Holding | | | | | in honeycomb | |
| | member | Covering member | | | Gas layer | structures (Note) | |
| | Material | Material | Shape | Layout state | Presence | Breakage | Frictional damage |
| Example 1 | PP | PE | bag-shaped | sealed | present | absent | absent |
| Example 2 | PP | PVC | bag-shaped | sealed | present | absent | absent |
| Example 3 | PP | PP | bag-shaped | sealed | present | absent | absent |
| Example 4 | cardboard | PE | bag-shaped | sealed | present | absent | absent |
| Comparative Example 1 | PP | PE | sheet-shaped | affixed | absent | absent | 1/5 (0.7 mg) |
| Comparative Example 2 | cardboard | PE | sheet-shaped | affixed | absent | absent | 1/5 (5.1 mg) |
| Comparative Example 3 | PP | NA (Note) | NA | NA | absent | 1/5 | 5/5 (15.3 mg) |

(Note)
NA = Not Available
The number of honeycomb structures in which breakage or frictional damage occurred among the honeycomb structures (five pieces) that have been packed is shown.
Moreover, the weight (mg) of ceramic powder generated due to frictional damage is shown by the value inside parentheses

These results indicate that, in Examples 1 to 4, neither breakage nor frictional damage occurred in the honeycomb structures after the vibration tests, and by using the packing members for honeycomb structures of Examples 1 to 4, the occurrence of deterioration in the honeycomb structures could be prevented. Moreover, the fouling of the holding member due to ceramic powder could be prevented.

In contrast, in Comparative Examples 1 and 2, although none of the honeycomb structures after the vibration tests had breakage, they had frictional damage, with amounts of generated ceramic powder being measured to 0.7 mg and 5.1 mg, respectively.

Moreover, in the packing member for honeycomb structures of Comparative Example 3, breakage occurred in one portion of honeycomb structures. Furthermore, 15.3 mg of ceramic powder was generated, indicating that serious frictional damage occurred in the honeycomb structures.

Furthermore, any of the packing members for honeycomb structures of Comparative Examples 1 to 3 had the generated ceramic powder adhered to their holding members.

### Second Embodiment

The following description will discuss a second embodiment that is one embodiment of the present invention.

In the present embodiment, a covering member prior to the sealing of the holding member to be used upon manufacturing the packing member for honeycomb structures has a tube shape with two opening portions. Here, the packing member for honeycomb structures of the present embodiment has the same structure as that of the first embodiment, except that sealing portions are formed on the neighborhoods of the respective opening portions of the covering member by thermal compression bonding or the like and that the holding member is sealed by sealing each of the opening portions.

Moreover, the method for transporting honeycomb structures of the present embodiment is the same as the method for transporting honeycomb structures of the first embodiment, except that the packing member for honeycomb structures to be used is different from each other.

The above-mentioned second embodiment also exerts the effects (1) to (6) described in the first embodiment.

The following description will discuss Examples that specifically disclose the second embodiment of the present invention. However, the present embodiment is not intended to be limited only by these Examples.

### Example 5

By carrying out the process (2) of Example 1, a covering member in a tubiform made of polyethylene, which had two opening portions and dimensions of 800 mm in length×382 mm in aperture diameter (each of the two opening portions)×0.04 mm in thickness, was prepared, and by covering the holding member with the tubiform, the holding member covered with the covering member was manufactured. Moreover, a packing member for honeycomb structures was manufactured in the same manner as in Example 1, except that, in the process (4) of Example 1, the neighborhoods of the two opening portions of the tubiform were sealed by thermal compression bonding so that the two sealed portions were formed.

Vibration tests were carried out in the same manner as in Example 1 on the packing member for honeycomb structures manufactured in Example 5, and evaluation was made as to whether or not any deterioration occurred in the honeycomb structures.

As a result, neither breakage nor frictional damage occurred in the honeycomb structures after the vibration tests.

Moreover, when the surface of the holding member was observed with the covering member removed therefrom, no fouling due to ceramic powder occurred.

Therefore, in the same manner as in the packing member for honeycomb structures of the first embodiment, the packing member for honeycomb structures of the second embodiment also made it possible to prevent the occurrence of deterioration in the honeycomb structures. Moreover, fouling of the holding member due to ceramic powder was also prevented.

### Third Embodiment

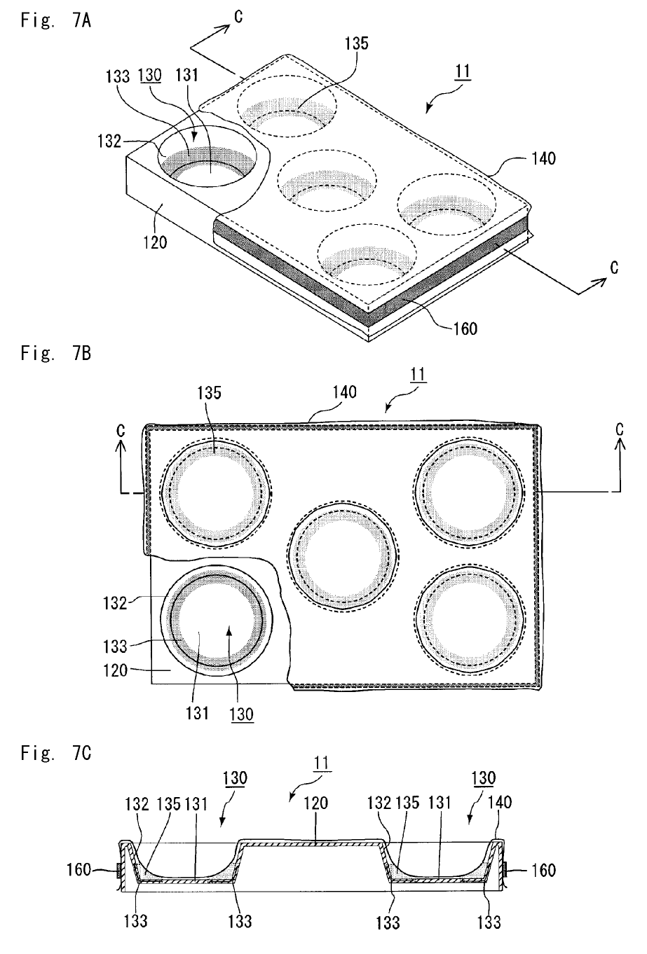

Referring to FIGS. 7A, 7B and 7C, the following description will discuss a third embodiment that is another embodiment of the present invention.

FIG. 7A is a perspective view that schematically shows another example of a packing member for honeycomb structures according to one embodiment of the present invention, and FIG. 7B is a plan view of the packing member for honeycomb structures shown in FIG. 7A.

FIG. 7C is a cross-sectional view that schematically shows a cross section obtained by cutting the packing member for honeycomb structures shown in FIG. 7A in a direction perpendicular to the bottom face of a recessed portion of a holding member (C-C line cross-sectional view of FIGS. 7A and 7B).

Here, FIGS. 7A and 7B show a state in which one portion of a covering member is cut out so as to show the recessed portion of the holding member.

Moreover, in the following description, a face on which the recessed portions of the holding member are formed in a packing member for honeycomb structures is referred to as the upper face of the holding member (upper face of a packing member for honeycomb structures), a face opposite to the upper face is referred to as the lower face of the holding member (lower face of the packing member for honeycomb structures), and a face perpendicular to the upper face is referred to as the side face of the holding member (side face of the packing member for honeycomb structures).

As shown in FIGS. 7A, 7B and 7C, a packing member 1 for honeycomb structures according to the embodiment of the present invention is configured by a holding member 120 on which recessed portions are formed, and a covering member 140 made of a resin sheet that covers the entire upper face of the holding member 120 and most of the side face thereof. Here, the covering member 140 is pressed onto the side face of the holding member 120 by a securing member 160 such as an adhesive tape so that the covering member 140 and the holding member 120 are secured to each other.

In this packing member for honeycomb structures of the present embodiment, in the same manner as in the first embodiment, the recessed portion 130 of the holding member 120 is provided with a corner portion 133 including: a border portion between a bottom face 131 and a side face 132; and the neighborhood of the border portion. Moreover, the entire upper face and most of the side face of the holding member 120 are covered with the covering member 140, and the holding member 120 and the covering member 140 are mutually secured by the securing member 160 so that a gas layer 135 is formed between the corner portion 133 and the covering member 140.

The other structures of the packing member for honeycomb structures in the present embodiment are the same as those of the first embodiment; therefore, the detailed description thereof will be omitted.

The following description will discuss a method for manufacturing the packing member for honeycomb structures of the present embodiment.

First, in the same manner as in the first embodiment, a plate-shaped member, such as a resin and cardboard, is processed to manufacture a holding member.

Next, a sheet-shaped covering member having a size capable of covering the entire upper face and most of the side face of the holding member is prepared, and by covering the entire upper face and most of the side face of the holding member with this covering member, the holding member covered with the covering member is manufactured.

Lastly, with respect to the holding member covered with the covering member, the covering member is pressed onto the side face of the holding member by using a securing member such as an adhesive tape so that the covering member and the holding member are secured to each other.

Through the above-mentioned processes, the packing member for honeycomb structures of the present embodiment is manufactured.

Moreover, the method for transporting honeycomb structures of the present embodiment is the same as the method for transporting honeycomb structures of the first embodiment except that the packing member for honeycomb structures is different.

The above-mentioned third embodiment also makes it possible to exert the effects (1) to (3) and (6) described in the first embodiment.

The following description will discuss Examples that specifically disclose the third embodiment of the present invention. However, the third embodiment is not intended to be limited only by these Examples.

### Example 6

### (1) Manufacturing of Holding Member

A holding member was manufactured by using the same process (1) in Example 1.

### (2) Covering

A sheet-shaped covering member, which was made of a polyethylene resin sheet having a size of 800 mm in width×600 mm in length×0.04 mm in thickness, was prepared. Moreover, by covering the entire upper face and most of the side face of the holding member manufactured in the process (1), a holding member covered with the covering member was manufactured.

### (3) Securing

By pressing the covering member onto the side face of the holding member with an adhesive tape, the covering member and the holding member were secured to each other so that a packing member for honeycomb structures was manufactured.

### Example 7

A packing member for honeycomb structures was manufactured in the same manner as in Example 6, except that in the process (1) in Example 6, a plate-shaped member made of cardboard having a thickness of 7 mm was processed to manufacture a holding member.

Vibration tests were carried out in the same manner as in Example 1 on each of the packing members for honeycomb structures manufactured in Examples 6 and 7, and evaluation was made as to whether or not any deterioration occurred in the honeycomb structures.

As a result, neither breakage nor frictional damage occurred in the honeycomb structures after the vibration tests.

Therefore, in the same manner as in the packing member for honeycomb structures of the first embodiment, the packing member for honeycomb structures of the third embodiment also made it possible to prevent the occurrence of deterioration in the honeycomb structures.

### Fourth Embodiment

The following description will discuss a fourth embodiment that is still another embodiment of the present invention.

The packing member for honeycomb structures of the present embodiment has the same structure as that of the third embodiment except that the covering member in the third embodiment and the side face of the holding member are secured to each other through thermal compression bonding. That is, in the same manner as in the first embodiment, each of the recessed portions of the holding member has a corner portion including: a border portion between the bottom face and the side face; and the neighborhood of the border portion. Here, the entire upper face and most of the side face of the holding member are covered with the covering member, and the holding member and the covering member are secured to each other through thermal compression bonding so that a gas layer is formed between the corner portion and the covering member.

Moreover, the method for transporting honeycomb structures of the present embodiment is the same as the method for transporting honeycomb structures of the first embodiment except that the packing member for honeycomb structures is different.

The above-mentioned fourth embodiment also makes it possible to exert the effects (1) to (3) and (6) described in the first embodiment.

The present embodiment can also exert the following effects.

(7) A gas layer is formed between the covering member and the corner portion, that is, between the covering member and the holding member. Moreover, the holding member and the covering member are firmly sealed by thermal compression bonding. For this reason, the packing member for honeycomb structures of the present embodiment is less susceptible to leakage of the gas in the gas layer through a gap between the holding member and the covering member, and it may become easier to maintain the gas layer with elasticity.

The following description will discuss Examples that specifically disclose the fourth embodiment of the present invention. However, the fourth embodiment is not intended to be limited only by these Examples.

### Example 8

A packing member for honeycomb structures was manufactured in the same manner as in Example 6, except that in the process (3) in Example 6, the holding member and the covering member were secured to each other on the side face of the holding member through thermal compression bonding.

Vibration tests were carried out in the same manner as in Example 1 on the packing member for honeycomb structures manufactured in Example 8, and evaluation was made as to whether or not any deterioration occurred in the honeycomb structures.

As a result, neither breakage nor frictional damage occurred in the honeycomb structures after the vibration tests.

Therefore, in the same manner as in the packing member for honeycomb structures of the first embodiment, the packing member for honeycomb structures of the fourth embodiment also made it possible to prevent the occurrence of deterioration in the honeycomb structures.

### Fifth Embodiment

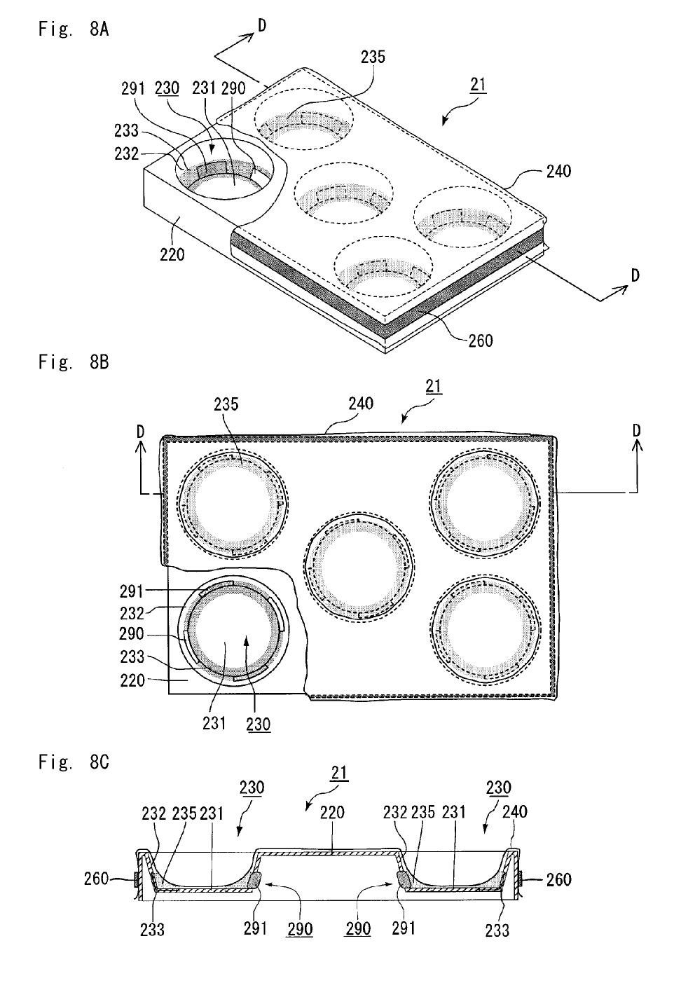

Referring to FIGS. 8A, 8B and 8C, the following description will discuss a fifth embodiment that is still another embodiment of the present invention.

FIG. 8A is a perspective view that schematically shows still another example of a packing member for honeycomb structures according to the embodiment of the present invention, and FIG. 8B is a plan view of the packing member for honeycomb structures shown in FIG. 8A.

FIG. 8C is a cross-sectional view that schematically shows a cross section obtained by cutting the packing member for honeycomb structures shown in FIG. 8A in a direction perpendicular to the bottom face of a recessed portion of a holding member (D-D line cross-sectional view of FIGS. 8A and 8B).

Here, FIGS. 8A and 8B show a state in which one portion of a covering member is cut out so as to show the recessed portion of the holding member.

In the same manner as in the first embodiment, a packing member for honeycomb structures 21 according to the embodiment of the present invention, shown in FIGS. 8A, 8B and 8C, is provided with each of recessed portions 230 of a holding member 220 that has a corner portion 233 including: a border portion between a bottom face 231 and a side face 232; and the neighborhood of the border portion. Here, the entire upper face and most of the side face of the holding member 220 is covered with a covering member 240, and the holding member 220 and the covering member 240 are secured to each other by a securing member 260 so that a gas layer 235 is formed between the corner portion 233 and the covering member 240.

Moreover, in the packing member for honeycomb structures of the present embodiment, a vent 290 is formed on the corner portion 233 on the side face 231 side, by penetrating the holding member 220. For this reason, a gas is allowed to come into and go out from the gas layer 235 through the vent 290. Moreover, the vent 290 is closed by a plugging member 291 such as a rubber plug so that the vent 290 can be opened and closed.

Therefore, in the case when the packing member for honeycomb structures of the present embodiment is used, after honeycomb structures have been held on the holding member with the gas layer interposed therebetween, the gas layer is further filled with the gas through the vent by using an air pump or the like, and the vent is then closed by a plugging member such as a rubber plug, or after the gas has been sucked from the gas layer through the vent by using an air pump or the like, the vent is closed by a plugging member such as a rubber plug; thus, the elasticity of the gas layer can be adjusted on demand.

The other structures of the packing member for honeycomb structures in the present embodiment are the same as those of the third embodiment; therefore, the detailed description thereof will be omitted.

Moreover, the method for transporting honeycomb structures of the present embodiment is the same as the method for transporting honeycomb structures of the first embodiment except that the packing member for honeycomb structures to be used is different.

The present embodiment also makes it possible to exert the effects (1) to (3) and (6) described in the first embodiment.

Moreover, the present embodiment can also exert the following effects.

(8) By taking into account the number, the outer shape and the like of honeycomb structures to be packed, the packing member for honeycomb structures of the present embodiment makes it easier to adjust the elasticity of the gas layer formed between the covering member and the corner portion so as to allow the gas layer to more effectively absorb the impact. For this reason, in the case when honeycomb structures are packed in the packing member for honeycomb structures of the present embodiment and when an impact is applied to the packing member for honeycomb structures, the impact to be applied to the honeycomb structures tends to be effectively absorbed by the gas layer so that the occurrence of breakage in the honeycomb structures tends to be prevented more effectively.

(9) Moreover, by taking into account the number, the outer shape and the like of honeycomb structures to be packed, it may become easier to adjust the elasticity of the gas layer formed between the covering member and the corner portion so as to more effectively prevent the occurrence of a gap between the gas layer forming portion and the honeycomb structures. For this reason, even in the case when honeycomb structures are packed in the packing member for honeycomb structures of the present embodiment and when an impact such as vibration is continuously applied thereto, the shape of the gas layer forming portion tends to be readily returned to its original shape due to the elasticity of the gas layer. Therefore, it may become easier to more effectively prevent the occurrence of a gap between: the covering member; and the outer edge portion of the end face of the honeycomb structure and the neighborhood of the outer edge portion. Since it may become easier to prevent a stress generated in the honeycomb structures by the stress transmitted thereto through the covering member from increasing, it may consequently become easier to more efficiently prevent the occurrence of frictional damage in the honeycomb structures.

The following description will discuss Examples that specifically disclose the fifth embodiment of the present invention. However, the present embodiment is not intended to be limited only by these Examples.

### Example 9

In this Example, a packing member for honeycomb structures was manufactured in the same manner as in Example 6, except that a through hole (diameter: 3 mm) was formed on the side face of each recessed portion of the holding member used in Example 6 to provide a vent therein so that a holding member with the vent was manufactured.

After honeycomb structures had been packed by this packing member for honeycomb structures, the gas layer was filled with air through the vent by using an air pump. Thereafter, the elasticity of the gas layer was adjusted by closing the vent with a plugging member made of a rubber plug.

### Example 10

A packing member for honeycomb structures was manufactured in the same manner as in Example 9, except that, instead of forming the vent through the side face of each recessed portion of the holding member, a vent was formed on the bottom face of each recessed portion to manufacture a holding member with the vent.

Vibration tests were carried out in the same manner as in Example 1 on each of the packing members for honeycomb structures manufactured in Examples 9 and 10, and evaluation was made as to whether or not any deterioration occurred in the honeycomb structures.

As a result, neither breakage nor frictional damage occurred in the honeycomb structures after the vibration tests.

Therefore, in the same manner as in the packing member for honeycomb structures of the first embodiment, the packing member for honeycomb structures of the fifth embodiment also made it possible to prevent the occurrence of deterioration in the honeycomb structures.

### Other Embodiments

The holding member, which is one component of the packing member for honeycomb structures according to one embodiment of the present invention, is desirably made of a material which has such strength that it is not deformed in its shape by an impact applied from the outside in processes such as packing and transportation of the honeycomb structures and that it is not deformed in its shape because it cannot fully support the weight of the honeycomb structures placed thereon.

In addition to the above-mentioned resin such as polypropylene (PP) and cardboard, specific examples of the material include; resins such as polyethylene terephthalate (PET), polyvinyl chloride (PVC), polycarbonate (PC), acryl, polyamide (PA), acrylonitrile butadiene styrene copolymer (ABS), and foamed polystyrene; wood; metal; and the like.

Moreover, the packing member for honeycomb structures according to the embodiment of the present invention may be formed by combining any of these materials. Specific examples of such an embodiment include a structure in which the holding member is made of cardboard, with the side face of each recessed portion of the holding member being made of foamed polystyrene.

Although not particularly limited, examples of the method for manufacturing the holding member having recessed portions in the manufacturing of the holding member include a resin molding method, such as a vacuum molding, an injection molding, and a press molding, in the case when the material for the holding member is resin.

Moreover, in the case when the material for the holding member is cardboard, for example, a method for carrying out machining and assembling through punching, cutting or the like may be used.

Although not particularly limited, the thickness of the holding member is desirably at least about 0.1 mm and at most about 0.5 mm, for example, in the case when the material for the holding member is polypropylene. The thickness of about 0.1 mm or more tends not to make the strength of the holding member insufficient, with the result that during processes such as packing and transportation of honeycomb structures, the shape of the holding member tends not to be deformed by an impact applied from the outside, or the shape of the holding member tends not to be deformed upon supporting the weight of the honeycomb structures placed thereon. Moreover, the thickness of about 0.5 mm or less makes it easier to process the holding member into a predetermined shape.

The outer shape of the holding member is not particularly limited since it is determined by the size of a box to contain honeycomb structures packed in the packing member for honeycomb structures, and it is desirably formed so that the distance between the side face of the box and the side face of the packing member for honeycomb structures is about 15 mm or less. In the case when the distance is about 15 mm or less, since the stress exerted between the box and the packing member for honeycomb structures tends not to be increased during processes such as packing and transportation of honeycomb structures, with the result that deterioration tends not to occur in the honeycomb structures.

Moreover, for the same reason, upon containing the honeycomb structures packed in the packing member for honeycomb structures into the box, the distance between the lower face of the upper side of the packing member for honeycomb structures and the upper face of the box is desirably about 15 mm or less.

The size of each recessed portion of the holding member is not particularly limited since it is determined by the size, the portion or the like of honeycomb structures to be placed on the recessed portion of the holding member, and, for example, in the case when the end portion of each honeycomb structure is placed on the recessed portion of the holding member, the diameter of the bottom face of the recessed portion is desirably at least about 5 mm and at most about 10 mm longer than the diameter (outer diameter) of the end face of the honeycomb structure to be placed thereon. This makes it possible to easily form a gas layer between the covering member and the corner portion of the holding member, and consequently to provide a packing member for honeycomb structures that can more effectively prevent the occurrence of deterioration in the honeycomb structures.

Moreover, the aperture diameter of the recessed portion is desirably made larger than the diameter of the bottom face in the recessed portion of the holding member, and it is, for example, at least about 2 mm and at most about 10 mm longer than the diameter of the bottom face of the recessed portion. Moreover, the height of the recessed portion is desirably a length corresponding to at least about ⅙ and at most about ½ of the length of the honeycomb structure to be placed thereon.

This allows the holding member to more surely hold the honeycomb structure, and makes it possible to provide a packing member for honeycomb structures that can more effectively prevent the occurrence of deterioration in the honeycomb structures.

Not particularly limited, the number of the recessed portions of the holding member may be altered on demand, depending on the sizes of the holding member and the honeycomb structures to be packed. For example, in the case when honeycomb structures are packed, with the end portion of each round pillar-shaped honeycomb structure having 143.8 mm in diameter×150 mm in length being placed on the recessed portion of the holding member, by using a packing member for honeycomb structures having an outer shape of 580 mm in width×380 mm in length×40 mm in height, the number of the recessed portions of the holding member on which the honeycomb structures are placed is desirably set to 4 to 6. The number of 4 or more does not make the number of honeycomb structures to be transported per one packing member for honeycomb structures too small, which tends not to result in high transporting costs. Moreover, the number of 6 or less does not make the number of honeycomb structures to be placed per one packing member for honeycomb structures too great, which tends not to cause insufficient strength in the holding member, with the result that the holding member tends to support the weight of the honeycomb structures placed thereon; this tends not to cause the shape of the holding member to be deformed.

The covering member, which is one component of the packing member for honeycomb structures according to one embodiment of the present invention, desirably has a high gas barrier property so that the covering member is placed, with a gas layer being interposed between the corner portion and the covering member, and also desirably has elasticity. Moreover, the covering member is desirably made less susceptible to adhesion of ceramic powder. And the covering members are desirably thermal compression bonded to each other, or the covering member is desirably thermal compression bonded to the holding member. In addition to the above-mentioned resins, such as polyethylene (PE), polyvinyl chloride (PVC), and polypropylene (PP), specific examples of the material include resins such as polyvinylidene chloride (PVDC), ethylene vinyl acetate copolymer (EVA), polyethylene terephthalate (PET), and polyamide (PA).

Although not particularly limited, the thickness of the covering member is desirably at least about 0.01 mm and at most about 0.2 mm, for example, in the case when the material for the covering member is polyethylene. The thickness of about 0.01 mm or more makes the thickness of the covering member not too thin, with the result that, during processes such as packing and transportation of honeycomb structures, rupturing or the like tends not to occur in the covering member. Moreover, the thickness of about 0.2 mm or less tends not to cause a reduction in the flexibility of the covering member, making it easier to place the covering member in a manner so as to form the gas layer between the covering member and the corner portion.

In the case when a sheet-shaped covering member (resin sheet) is used as the covering member for forming the packing member for honeycomb structures according to the embodiments of the present invention, its size, shape and the like thereof are not particularly limited, as long as it can cover at least the recessed portions of the holding member. In addition to the above-mentioned covering member having a size that can cover virtually the entire faces of the upper face and the side face of the holding member, there may be employed: a covering member having a size that can cover virtually the entire face of the upper face of the holding member; and a covering member having a size that can cover virtually the entire faces of the upper face, the side face and the lower face of the holding member, that is, the entire portions of the holding member.

With respect to the method for sealing the opening portion of the covering member in the sealing used upon manufacturing the packing member for honeycomb structures according to the embodiments of the present invention, in addition to the above-mentioned method using thermal compression bonding, for example, a method for sealing the opening portion with an adhesive agent and a method for binding the covering members near the opening portion with each other may be used. Among these methods, the sealing by thermal compression bonding is more desirably used. Since the thermal compression bonding makes it easier to firmly seal the opening portion, the sealing tends to be easily carried out, with low probability of leakage of the gas from the gas layer.

Not particularly limited to a bag-shaped or tube-shaped covering member, the covering member to be used in the sealing may be prepared as a sheet-shaped covering member. Upon using the sheet-shaped covering member, a sealing method is proposed in which two sheets of covering members are superposed on one another, the entire holding member is covered with the covering members, with the holding member being sandwiched therebetween, and the two sheets of the covering members are mutually sealed with each other on the entire peripheral edge portion thereof by using thermal compression bonding or the like so that the holding member is sealed with the covering members.

With respect to the method for adjusting the volume of gas between the covering member and the corner portion of the holding member, although not particularly limited, a method is proposed in which, after the holding member has been covered with the covering member, the inside of the covering member is filled with a gas, such as air and nitrogen. Moreover, with respect to the method for reducing the volume of the gas, although not particularly limited, a method is proposed in which, after the inside of the covering member has been once filled with the above-mentioned gas, the gas is sucked.

Moreover, with respect to the device used for the method for filling the gas and the device used for the method for sucking the gas, not particularly limited, a blower, a plunger or the like may be used in addition to the above-mentioned air pump.

Moreover, with respect to the method for opening and closing the vent upon forming the vent in the holding member, although not particularly limited, such a method that prevents the gas in the gas layer from leaking through the vent is desirably used. In addition to the method in which a plugging member made of an elastic member such as a rubber plug is attached to or removed from the vent, specific examples thereof include: a method for opening and closing a cock attached to the vent; a method in which the vent is closed by a resin sheet attached thereto; and the like.

Not particularly limited to the adhesive tape, examples of the securing member used for securing the sheet-shaped covering member and the holding member in the securing upon manufacturing the packing member for honeycomb structures according to the embodiments of the present invention include a rubber band, a wire, a string, and the like.

Moreover, with respect to the position of the holding member at which the sheet-shaped covering member and the holding member are secured, although not particularly limited, the covering member and the holding member may be secured on the side face of the holding member as described earlier, or the upper face of the holding member or the lower face of the holding member may be secured to the covering member.

Upon packing honeycomb structures by using the packing member for honeycomb structures according to the embodiments of the present invention, the honeycomb structures may be put into a resin bag and placed on the recessed portions of the holding member, with the opening portion of the resin bag being sealed. This makes it easier to prevent the occurrence of fouling on the holding member, the covering member and the box, even when flaking or the like occurs due to the occurrence of deterioration in the honeycomb structures during processes, such as packing and transportation of the honeycomb structures. Moreover, in the case when a plurality of honeycomb structures are placed on the holding member, each of the honeycomb structures are desirably put into a resin bag. This makes it easier to prevent ceramic powder or the like, generated from deteriorated honeycomb structures, from adhering to honeycomb structures having no deterioration, and thus, fouling in the honeycomb structures having no deterioration, the holding member, the covering member and the box tends not to occur.

In the method for transporting honeycomb structures according to the embodiments of the present invention, although not particularly limited, examples of the method for packing the honeycomb structures include a method in which side face portions of honeycomb structures are placed on the recessed portions of the holding member and the honeycomb structures are packed by two packing members for honeycomb structures, in a manner so as to be sandwiched from both upward and downward directions, in addition to the above-mentioned method in which the two ends (upper end and lower end) of each honeycomb structure are placed on the recessed portions of the holding member and the honeycomb structures are packed by two packing members for honeycomb structures, in a manner so as to be sandwiched from both upward and downward directions.

With respect to the method for containing the packing member for honeycomb structures in which the honeycomb structures have been packed in a box, although not particularly limited, the packing member for honeycomb structures in which honeycomb structures are packed may be contained, with the upper end portion of each honeycomb structure placed on the upper side and the lower end portion of each honeycomb structure placed on the lower side in the box, or may be contained, with the upper end portion of each honeycomb structure placed on the lower side and the lower end portion of each honeycomb structure placed on the upper side in the box. Moreover, the packing member for honeycomb structures in which the honeycomb structures have been packed may be contained, with the upper end portion and the lower end portion of each honeycomb structure placed laterally in the box.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A packing member for a honeycomb structure, comprising:
a holding member which includes a recessed portion having a bottom face and a side face and which is configured to hold the honeycomb structure in the recessed portion, said recessed portion comprising a corner portion including a border portion between said bottom face and said side face; and
a covering member covering at least said recessed portion and provided to form a gas layer between said covering member and said corner portion.

2. The packing member for a honeycomb structure according to claim 1,
wherein
said covering member is made of a resin.

3. The packing member for a honeycomb structure according to claim 2,
wherein
said resin comprises at least one of polyethylene, polyvinyl chloride, polypropylene, polyvinylidene chloride, ethylene vinyl acetate copolymer, polyethylene terephthalate, and polyamide.

4. The packing member for a honeycomb structure according to claim 2,
wherein
said resin is polyethylene, and
a thickness of said covering member is at least about 0.01 mm and at most about 0.2 mm.

5. The packing member for a honeycomb structure according to claim 1,
wherein
a material of said holding member comprises at least one of polypropylene, polyethylene terephthalate, polyvinyl chloride, polycarbonate, acryl, polyamide, acrylonitrile-butadiene-styrene copolymer, and foamed polystyrene.

6. The packing member for a honeycomb structure according to claim 1,
wherein
a material of said holding member comprises cardboard.

7. The packing member for a honeycomb structure according to claim 1,
wherein
said holding member comprises cardboard and foamed polystyrene, and the side face of the recessed portion is made of said foamed polystyrene.

8. The packing member for a honeycomb structure according to claim 1,
wherein
a diameter of the bottom face of said recessed portion is at least about 5 mm and at most about 10 mm larger than a diameter of the honeycomb structure.

9. The packing member for a honeycomb structure according to claim 1,
wherein
an aperture diameter of an opening of said recessed portion is larger than a diameter of the bottom face of said recessed portion.

10. The packing member for a honeycomb structure according to claim 9,
wherein
the aperture diameter of said recessed portion is at least about 2 mm and at most about 10 mm larger than the diameter of the bottom face of said recessed portion.

11. The packing member for a honeycomb structure according to claim 1,
wherein
a height of said recessed portion is at least about ⅙ and at most about ½ of a length of said honeycomb structure.

12. The packing member for a honeycomb structure according to claim 1,
wherein
said covering member covers an entire portion of said holding member.

13. The packing member for a honeycomb structure according to claim 12,
wherein
said holding member is provided in said covering member which is sealed.

14. The packing member for a honeycomb structure according to claim 13,
wherein
said covering member has a bag shape with one opening portion or a tube shape with plural opening portions before said covering member is sealed.

15. The packing member for a honeycomb structure according to claim 14,
wherein
said opening portion or the plural opening portions are sealed by thermal compression bonding.

16. The packing member for a honeycomb structure according to claim 14,
wherein
said opening portion or the plural opening portions are sealed with an adhesive agent or by binding said covering members in a vicinity of said opening portion or the plural opening portions.

17. The packing member for a honeycomb structure according to claim 1,
wherein
said holding member and said covering member are fixed to each other.

18. The packing member for a honeycomb structure according to claim 17,
wherein
said holding member and said covering member are fixed to each other by a securing member.

19. The packing member for a honeycomb structure according to claim 18,
wherein
said securing member comprises an adhesive tape.

20. The packing member for a honeycomb structure according to claim 17,
wherein
said holding member and said covering member are fixed to each other by thermal compression bonding.

21. The packing member for a honeycomb structure according to claim 17,
wherein
said holding member has a vent that allows a gas to come in and go out of said gas layer, and
said vent is capable of being opened and closed.

22. The packing member for a honeycomb structure according to claim 21,
wherein
said vent is disposed on said side face or said bottom face of said recessed portion.

23. The packing member for a honeycomb structure according to claim 21, further comprising:
a plugging member made of an elastic member and capable of being attached to or removed from said vent.

24. The packing member for a honeycomb structure according to claim 21, further comprising:
a cock attached to said vent and capable of being opened and closed.

25. The packing member for a honeycomb structure according to claim 21, further comprising:
a resin sheet capable of being attached to or removed from said vent.

26. The packing member for a honeycomb structure according to claim 1, further comprising:
a resin bag into which said honeycomb structure is put.

27. A method for transporting a honeycomb structure, said method comprising:
providing a packing member for a honeycomb structure, the packing member comprising:
a holding member which includes a recessed portion having a bottom face and a side face and which is configured to hold the honeycomb structure in the recessed portion, said recessed portion comprising a corner portion including a border portion between said bottom face and said side face; and
a covering member covering at least said recessed portion and provided to form a gas layer between said covering member and said corner portion;
placing the honeycomb structure on the recessed portion of the holding member of the packing member;
packing said honeycomb structure with said packing member; and
transporting said packing member in which said honeycomb structure has been packed.

28. The method for transporting a honeycomb structure according to claim 27,
wherein
an upper end portion and a lower end portion of said honeycomb structure are placed on said recessed portions of said holding member to pack said honeycomb structure in said packing member.

29. The method for transporting a honeycomb structure according to claim 27,
wherein
said transporting is carried out by containing in a box said packing member in which said honeycomb structure is packed.

30. The method for transporting a honeycomb structure according to claim 29,
wherein
said honeycomb structure packed in said packing member for a honeycomb structure is contained in said box,
with an upper end portion of said honeycomb structure placed on an upper side and a lower end portion of said honeycomb structure placed on a lower side, or
with the upper end portion of said honeycomb structure placed on the lower side and the lower end portion of said honeycomb structure placed on the upper side.

31. The method for transporting a honeycomb structure according to claim 29,
wherein
said honeycomb structure packed in said packing member for a honeycomb structure is contained in the box, with the upper end portion and the lower end portion of said honeycomb structure placed laterally.

32. The method for transporting a honeycomb structure according to claim 27,
wherein
said covering member is made of a resin.

33. The method for transporting a honeycomb structure according to claim 32,
wherein
said resin comprises at least one of polyethylene, polyvinyl chloride, polypropylene, polyvinylidene chloride, ethylene vinyl acetate copolymer, polyethylene terephthalate, and polyamide.

34. The method for transporting a honeycomb structure according to claim 32,
wherein
said resin is polyethylene, and
a thickness of said covering member is at least about 0.01 mm and at most about 0.2 mm.

35. The method for transporting a honeycomb structure according to claim 27,
wherein
a material of said holding member comprises at least one of polypropylene, polyethylene terephthalate, polyvinyl chloride, polycarbonate, acryl, polyamide, acrylonitrile-butadiene-styrene copolymer, and foamed polystyrene.

36. The method for transporting a honeycomb structure according to claim 27,
wherein
a material of said holding member comprises cardboard.

37. The method for transporting a honeycomb structure according to claim 27,
wherein
said holding member comprises cardboard and foamed polystyrene, and
the side face of the recessed portion of said holding member is made of said foamed polystyrene.

38. The method for transporting a honeycomb structure according to claim 27,
wherein
a diameter of the bottom face of said recessed portion is at least about 5 mm and at most about 10 mm larger than a diameter of the honeycomb structure.

39. The method for transporting a honeycomb structure according to claim 27,
wherein
an aperture diameter of an opening of said recessed portion is larger than a diameter of the bottom face of said recessed portion.

40. The method for transporting a honeycomb structure according to claim 39,
wherein
the aperture diameter of said recessed portion is at least about 2 mm and at most about 10 mm larger than the diameter of the bottom face of said recessed portion.

41. The method for transporting a honeycomb structure according to claim 27,
wherein
a height of said recessed portion is at least about ⅙ and at most about ½ of a length of said honeycomb structure.

42. The method for transporting a honeycomb structure according to claim 27,
wherein
said covering member covers an entire portion of said holding member.

43. The method for transporting a honeycomb structure according to claim 42,
wherein
said holding member is provided in said covering member which is sealed.

44. The method for transporting a honeycomb structure according to claim 43,
wherein
said covering member has a bag shape with one opening portion or a tube shape with plural opening portions before said covering member is sealed.

45. The method for transporting a honeycomb structure according to claim 44,
wherein
said opening portion or the plural opening portions are sealed by thermal compression bonding.

46. The method for transporting a honeycomb structure according to claim 44,
wherein
said opening portion or the plural opening portions are sealed with an adhesive agent or by binding said covering members in a vicinity of said opening portion or the plural opening portions.

47. The method for transporting a honeycomb structure according to claim 27,
wherein
said holding member and said covering member are fixed to each other.

48. The method for transporting a honeycomb structure according to claim 47,
wherein
said holding member and said covering member are fixed to each other by a securing member.

49. The method for transporting a honeycomb structure according to claim 48,
wherein
said securing member comprises an adhesive tape.

50. The method for transporting a honeycomb structure according to claim 47,
wherein
said holding member and said covering member are fixed to each other by thermal compression bonding.

51. The method for transporting a honeycomb structure according to claim 47,
wherein
said holding member has a vent that allows a gas to come in and go out of said gas layer, and
said vent is capable of being opened and closed.

52. The method for transporting a honeycomb structure according to claim 51,
wherein
said vent is disposed on said side face or said bottom face of said recessed portion.

53. The method for transporting a honeycomb structure according to claim 51,
wherein
said packing member further comprises a plugging member made of an elastic member,
said plugging member being capable of being attached to or removed from said vent.

54. The method for transporting a honeycomb structure according to claim 51,
wherein
said packing member further comprises a cock attached to said vent,
said cock being capable of being opened and closed.

55. The method for transporting a honeycomb structure according to claim 51,
wherein
said packing member for a honeycomb structure further comprises a resin sheet capable of being attached to or removed from said vent.

56. The method for transporting a honeycomb structure according to claim 27,
wherein
said packing member for a honeycomb structure further comprises a resin bag into which said honeycomb structure is put.
